(19) United States
(12) Patent Application Publication
(10) Pub. No.: US 2004/0046039 A1
(43) Pub. Date: Mar. 11, 2004

(54) Underfloor heating system

(76) Inventor: Felix Mueller, Biebergemuend (DE)

Correspondence Address: Karl F Milde Jr, Milde & Hoffberg, Suite 460, 10 Bank Street, White Plains, NY, 10606, US

(21) Appl. No.: 10/250,734

(22) PCT Filed: Jan. 3, 2002
(86) PCT No.: PCT/EP02/00017

(30) Foreign Application Priority Data
Jan. 10, 2001 (DE) 10100926.7

(51) Int. Cl. B60H 1/02

(52) U.S. Cl. 237/2 A

(57) ABSTRACT

The invention relates to an underfloor heating system in which hot-air is guided through an air conduit system that is disposed below a floor screed. The inventive system is characterized in that the area of the floor surfaces to be heated the air conduit system is configured by a porous bulk layer of bodies having a high thermal capacity. The porosity of said layer ranges between 10 and 80% by volume and is delimited by an air-tight film or film-type layer on its upper and lower surfaces.

The present invention relates to an underfloor heating system in which hot air is guided through an air conduit system that is disposed below a floor screed.

Underfloor heating systems of this type offer advantages—because of their large heating surfaces and consequently the high amount of radiant heat-over heating systems using radiators. In addition, underfloor heating systems provide perfect room conditions in comparison with heating systems using radiators.

Underfloor heating systems that are widely used are those in the case of which hot water flows through pipe systems arranged below the screed. Special precautionary measures for the protection of the screed must be taken for such underfloor heating systems having water flowing therethrough because of the high energy density of water. Moreover, a uniform energy distribution across the floor surface requires special measures; normally, such pipes for underfloor heating systems are arranged in specific laying patterns in the case of which neighboring pipes are normally spaced apart between 20 cm and 30 cm. However, a uniform laying of the pipes over large surfaces, particularly over angled surfaces, is not possible, so that surfaces that are heated to different degrees are created because of the laying pattern. Such underfloor heating systems with hot water supply are critical whenever water leakages arise. Repair work is only possible under high repair efforts; in many cases the whole floor construction must be replaced.

Apart from underfloor heating systems with hot water supply, there are also known underfloor heating systems with hot air conduction. Such hot-air heaters were already used in Roman architecture. With the tendency to build low-energy houses, air heating devices become increasingly popular because less heating energy has to be transported on account of the low heat demand. Distributor pipes with small cross sections of the pipes can e.g. be accommodated in low-energy single-family houses without any special constructional measures, for instance separate ducts. For distributing the air the air heating systems that are presently known and offered employ substantially smooth channels of metal or plastics that are laid in the screed floor. However, it has been found that a heat transfer by the air via the channel walls only takes place to a very small extent because there are no or hardly any heat transfers from the air to the channel wall and thus to the screed floor because of the reduced air velocities and the normally smooth channel walls.

It is the object of the present invention to provide an underfloor heating system with hot air conduction with which the screed floor can be heated in a uniform manner, which meets today's demands made on fire prevention, economy and environmental protection and which is characterized by high energy efficiency.

This object according to the invention is achieved by an underfloor heating system in which hot air is guided through an air conduit system disposed below a floor screed, which system is characterized in that in the area of the floor surfaces to be heated the air conduit system is configured by a porous bulk layer of bodies having a high thermal capacity, wherein the porosity of the layer ranges between 10 and 80% by volume and wherein the layer is delimited by an air-tight film or film-type layer on its upper and lower faces. Due to the porous bulk layer of bodies having a high thermal capacity and a porosity of the layer or a cavity volume between 10 and 20% by volume of the layer, there is an intensive whirling of the hot air guided through the layer. The individual bodies are forming small whirl bodies by the size and contour of which the whirling action can considerably be influenced, so that it is already through the selection of the bulk material or bodies that the underfloor heating system can be designed and dimensioned. The air guided through the porous layer discharges its heat energy to the bulk bodies or whirl bodies due to the strong whirling action. The whirl bodies, in turn, discharge their energy through heat conduction to the screed floor. Due to the natural stratification of air in such a way that the hot air layer is formed in the upper region, the upper whirl bodies of the porous bulk layer are preferably heated. Said bodies, being only separated by the film, are in direct heat-conducting contact with the screed floor. When the underfloor heating system is being built up, the film delimiting the porous layer is pressed by the pressure prevailing during casting of the screed against the bulk bodies, so that the film comes to rest on the bulk bodies or the contour thereof, resulting in a large contact surface between screed and bulk bodies. On account of their geometry, preferably a round or oval one or one having many edges, there is only a local contact between the individual bulk bodies, resulting in a preferred heat flow towards the screed concrete.

As has already been outlined above, such an underfloor heating system may be of a very simple construction in that in the area of the floor heating surfaces a lower, airtight film or a film-type layer is placed in the area of the floor heating surfaces on the raw floor, preferably on a layer of insulating material placed thereon, the porous layer of corresponding bulk bodies or material is then heaped up, and the upper cover film is then laid on said layer and the screed floor is cast. Hence, no troublesome laying work is needed for pipes or other channel systems, as is the case in conventional underfloor heating systems, particularly in those having a hot water heating. The bulk layer yields a very uniformly disturbed air conduction or cavity system in all regions without special measures being needed therefor. However, for achieving an additional influence on air flow and conduction, specific areas or area sections of the floor to be heated are formed with layers of differently large bodies, so that in different area sections of the floor a different cavity volume ranging from 10 to 80% by volume is obtained due to the porosity produced. Preferably, the porosity of the layer should be set such that it ranges from 30 to 40% by volume.

Mineral gravel is preferably used for building up the porous layer. Mineral gravel is an inexpensive material that also yields the necessary porosity. Furthermore, mineral gravel is obtainable in a very great variety, so that the underfloor heating system can be adapted to the respective requirements by selection of the gravel used. Apart from mineral gravel, the porous bulk layer is preferably configured by expanded clay spheres. Such a layer of expanded clay spheres should be used whenever a rapid heating up is needed whereas preference should always be given to mineral gravel whenever a highly uniform temperature is needed.

It has been found that the thickness of the porous layer should range from 1 cm to 10 cm and should preferably be at about 3.5 cm. Furthermore, the grain size of the porous layer should be within a range of from 8 mm to 32 mm.

The layer to be heated should be sealed circumferentially in air-tight fashion and should have at least one air supply region and at least one air discharge region, so that the hot air is force-guided through the porous layer from the air supply region to the air discharge region. The surrounding seal of the layer to be heated can be obtained in a simple way such that in the edge regions the bulk material is omitted and the screed floor is directly cast with the sub-floor. It is however also possible to introduce separate sealing elements into the floor structure, e.g. in the form of plastic hoses.

To achieve a continuous flow of hot air through the porous layer throughout the floor region to be heated, the air supply region and the air discharge region should preferably be positioned opposite relative to the porous layer, However, it is also possible to introduce additional supply and discharge channels or further distribution channels into the floor region to supply the porous layer with hot air.

To delimit the porous bulk layer of bodies on the upper and lower faces, a plastic film or a film-type layer of oil-impregnated paper is preferably used as the film. Both materials are available at low costs and can be laid easily in overlapping and thus air-tight fashion.

For a controlled air exchange throttling means may be arranged in the air supply regions, the throttling means distributing the supplied air such that it is either discharged into the room or discharged into the porous layer. In a very simple constructional form, gratings that vary the flow resistance are used for such throttling means in the supply region, optionally also in the discharge region. Such a throttling means, for instance a grating, can be designed such that it variably changes the cross section of the flow, thereby permitting a defined control of air supply and air distribution.

The air discharge regions via which the hot air guided through the porous layer is discharged into the room can preferably be arranged in window or wall regions representing cold bridges to the outside of the house. The floor heating system as outlined can also be equipped in a simple way with air humidifying means that are preferably installed in the air discharge region so that air directly discharged into the room can be humidified in a defined way.

The maximum air pressure in the porous layer should be less than 400 Pa.

In a heating system of a house in which the above-described underfloor heating system is used, the hot air rising within the house can be fed again into the heating system, so that the transmission losses of the external envelope, which are created by reason of the natural heat distribution, are reduced.

Further features and advantages of the invention become apparent from the following description of an embodiment with reference to the drawing, in which:

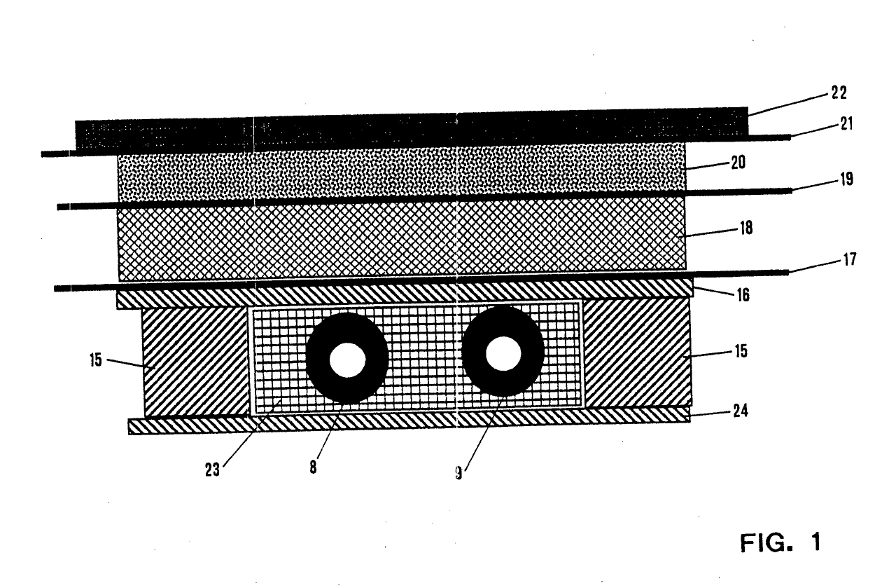

FIG. 1 is a section through a floor structure wherein the underfloor heating system of the invention is used together with the porous layer;

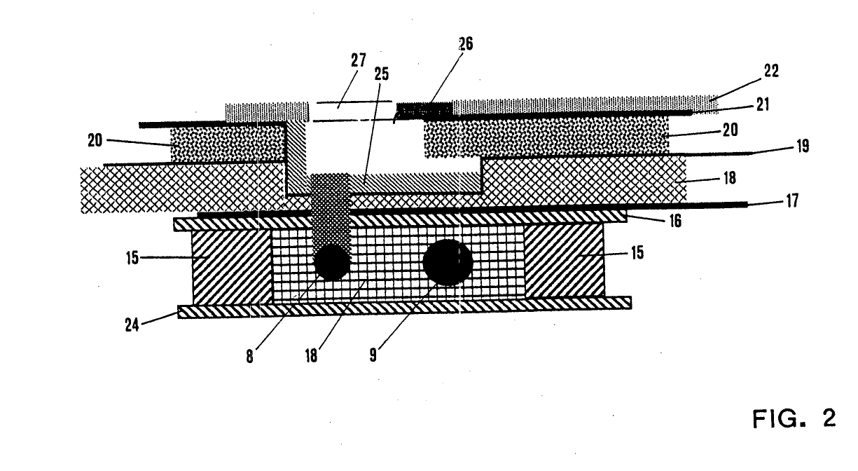

FIG. 2 is a further section through the floor structure, as is also shown in FIG. 1, in which a distribution channel can be seen; and

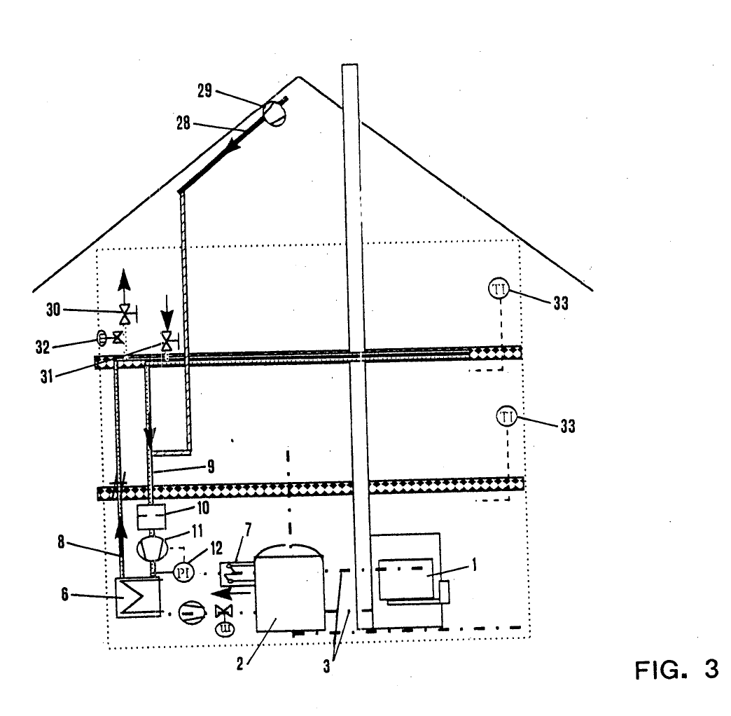

FIG. 3 is a section through a two-storied residential building, on the basis of which the overall structure of a heating system with the underfloor heating according to the invention is shown.

The heating system as is e.g. shown in FIG. 3 comprises a wood gasifier boiler 1 used for hot water generation, which is arranged in the basement area and connected to a stratified hot-water storage tank 2 [Schichtwarmwasserspeicher 2] via a corresponding pipe system 3. The stratified hot-water storage tank 2 is integrated into a circuit comprising a control valve 4, a pump 5 and a water/air heat exchanger 6. The water/air heat exchanger 6, in turn, is integrated into a hot-air circuit with a feed line 8, a return line 9, a filter 10, and an air circulation pump 11, a pump regulation/control means 12. Reference numeral 7 designates an electric heating rod that serves as an emergency/auxiliary heating means.

The two floor surfaces 13 and 14 shown in FIG. 3 of the ground floor and second floor of the illustrated house are each integrated between the feed line 8 and the return line 7. The construction of these two floor surfaces 13 and 14 is shown in more detail in FIGS. 1 and 2.

Wooden beams are laid as the supporting ceiling elements with suitable dimensions, e.g. with a cross section of 18 cm×18 cm. The feed pipes and discharge pipes 9, as shown in FIG. 3, as well as further supply pipes, e.g. for waste water, can be laid between these wooden beams 15. A wooden board layer 16 having a thickness of about 2 cm is put on the wooden beams 15, the layer 16 being optionally covered on its upper face with an impact sound insulation 17, at the place where sound insulation is desired, the insulation having a thickness of about 0.5 cm. Above the impact sound insulation 17, there is an insulting layer 18, e.g. of expanded polystyrene slabs having a thickness of 6 cm, which is covered on its upper side with a so-called screed film, which is a thin plastic film. Said screed film 19 forms the base or substrate for a porous bulk layer 20 formed from gravel, which, in turn, is covered on its upper side by a screed film 21. A completing screed layer is cast onto the screed film 21.

In the illustrated example, the porous layer 20 has a height of 3.5 cm; the same thickness is used for the screed layer 22. Furthermore, the cavities 23 can be filled between the wooden beams 15 and the feed line 8 and the return line 9 with additional insulating material, preferably mineral wool or sheep's wool, for ecological reasons. Moreover, the wooden beams 15 can be lined on their lower side with covering slabs or facing boards 24.

The screed films 19 and 21 may form a kind of box-shaped mattress, filled with the bodies forming the porous bulk layer, so that the porous layer 20 is uninterruptedly sealed.

As shown in FIG. 2, distributor channels 25, which may be trough-like parts that can extend into the insulating layer 18, are used at defined places of the floor construction, which is substantially identical with the construction of FIG. 1 in the illustration of FIG. 2. In such a distributor channel 25, hot air is supplied via the feed line 8 and passed from there into the porous layer 20. Such distributor channels 25 are covered on the upper side with a cover plate 26. Air gratings 27 that discharge a specific amount of hot air directly into the room may be used at defined places in said cover plate 26. The distribution ratio of the hot air into the porous layer 20, on the one hand, the hot air being supplied via the feed line 8 into the distributor channel 25, and of the hot air discharged via the air grating 27 into the room, on the other hand, can be adjusted by changing the opening cross-section of said air gratings 27.

As becomes apparent from FIGS. 1 and 2, a very efficient underfloor heating system with hot air conduction below the floor screed can be constructed by way of the porous layer 20, which is respectively covered on the upper and lower faces with a film 19, 21.

As can further be seen in FIG. 3, in the roof area of the house a hot air suction means 28 with a pump 29 is installed for sucking off the hot air that is collecting below the roof surface, and for feeding the hot air into the return line 9 to the water/air heat exchanger.

Furthermore, in FIG. 3 in the area of the floor of the upper ceiling, valves are provided, which are designated by reference numerals 30, 31 and serve to directly control the air flow through the room. A temperature sensor 32 serves the control of the air flow. Reference numeral 33 designates a temperature indicator or sensor. In summer the heating system can also be fed for air-conditioning purposes with cold air that is generated by any desired source, e.g. a refrigerating unit, a ground-air heat exchanger, or the like.

1. An underfloor heating system in which hot air is guided through an air conduit system disposed below a floor screed, characterized in that in the area of the floor surfaces to be heated the air conduit system is configured by a porous bulk layer (20) of bodies having a high thermal capacity, wherein the porosity of said layer (20) ranges between 10 and 80% by volume and wherein said layer (20) is delimited by an air-tight film (21, 19) or film-type layer on its upper and lower faces.

2. The underfloor heating system according to claim 1, characterized in that the porosity of said layer (20) is between 30 and 40% by volume.

3. The underfloor heating system according to claim 1, characterized in that said porous layer (20) is formed from mineral gravel.

4. The underfloor heating system according to claim 1, characterized in that said porous layer is formed from expanded clay spheres.

5. The underfloor heating system according to any one of claims 1 to 4, characterized in that the grain size of said porous layer (20) ranges from 8 mm to 32 mm.

6. The underfloor heating system according to claim 1, characterized in that said layer (20) has a thickness of 1 cm to 10 cm, preferably about 3.5 cm.

7. The underfloor heating system according to claim 1, characterized in that said layer (20) to be heated is circumferentially sealed in air-tight fashion and comprises at least one air supply region (8) and at least one air discharge region such that the hot air is force-guided through said porous layer (20) from said air supply region (8) to said air discharge region.

8. The underfloor heating system according to claim 7, characterized in that said air supply region and said air discharge region are positioned to be opposite relative to said porous layer (20).

9. The underfloor heating system according to claim 1, characterized in that said film (19, 21) is a plastic film.

10. The underfloor heating system according to claim 1, characterized in that said film-type layer is formed from oil-impregnated paper.

11. The underfloor heating system according to claim 1, characterized in that a layer of insulating material is arranged below said porous layer (20) and said film (19, 21) or said film-like layer (18).

12. The underfloor heating system according to claim 7, characterized in that said air supply region (8) has disposed therein a throttling means (27) that distributes the supplied air such that it is either discharged into a room or discharged into said porous layer (20).

13. The underfloor heating system according to claim 7, characterized in that an air humidifying means is arranged in said air discharge region.

14. The underfloor heating system according to claim 1, characterized in that an operating pressure of less than 400 Pa is set within said porous layer (20).
